(19) United States
(12) Patent Application Publication
(10) Pub. No.: US 2021/0239130 A1
(43) Pub. Date: Aug. 5, 2021

(54) CENTRIFUGAL COMPRESSOR DIFFUSER STRUCTURE AND CENTRIFUGAL COMPRESSOR

(71) Applicant: MITSUBISHI HEAVY INDUSTRIES, LTD., Tokyo (JP)

(72) Inventors: Tadashi KANZAKA, Tokyo (JP); Teng CAO, Cambridge (GB)

(21) Appl. No.: 17/137,613

(22) Filed: Dec. 30, 2020

(30) Foreign Application Priority Data
Feb. 4, 2020 (JP) 2020-017088

(51) Int. Cl. F04D 29/44

(52) U.S. Cl. CPC F04D 29/444

(57) ABSTRACT

A centrifugal compressor diffuser structure according to at least one embodiment of the present disclosure is a centrifugal compressor diffuser structure provided on a downstream side of an impeller of the centrifugal compressor, and includes a hub-side wall surface, a shroud-side wall surface defining, together with the hub-side wall surface, a diffuser flow path, and a partial guide vane provided on at least one of the hub-side wall surface and the shroud-side wall surface. Given that a vane height of the partial guide vane is a, and an axial height of the diffuser flow path is H, a relationship of 0.05 H≤a≤0.20 H is satisfied.

### CROSS-REFERENCE TO RELATED APPLICATIONS

This application claims the benefit of priority to Japanese Patent Application Number 2020-017088 filed on Feb. 4, 2020. The entire contents of the above-identified application are hereby incorporated by reference.

### TECHNICAL FIELD

The present disclosure relates to a centrifugal compressor diffuser structure and a centrifugal compressor.

### RELATED ART

Centrifugal compressors used in a compressor section and the like of a turbocharger for vehicles, vessels, and industrial use provide kinetic energy to fluid via the rotation of an impeller and discharge the fluid outwards in the radial direction to acquire a pressure increase due to a centrifugal force.

Various approaches have been made to improve the performance of centrifugal compressors. One example is an improvement in the static pressure recovery performance (diffuser performance) in a diffuser provided on the downstream side of the impeller of the centrifugal compressor. For example, JP 2001-329996 A describes a centrifugal compressor provided with a retractable guide blade on a diffuser section (see JP 2001-329996 A).

### SUMMARY

### Technical Problem

However, the centrifugal compressor described in Patent Document 1 requires a drive mechanism that allows the guide blade to be retracted into and out of the diffuser section, making the configuration of the centrifugal compressor complicated.

In light of the above circumstances, an object of at least one embodiment of the present disclosure is to improve the diffuser performance of a centrifugal compressor.

(1) A centrifugal compressor diffuser structure according to at least one embodiment of the present disclosure is a diffuser structure provided on a downstream side of an impeller of a centrifugal compressor, and includes:

a hub-side wall surface;

a shroud-side wall surface defining, together with the hub-side wall surface, a diffuser flow path; and

a partial guide vane provided on at least one of the hub-side wall surface and the shroud-side wall surface, and

given that a vane height of the partial guide vane is a, and

an axial height of the diffuser flow path is H,

a relationship of 0.05 H≤a≤0.20 H is satisfied.

(2) A centrifugal compressor according to at least one embodiment of the present disclosure includes: the centrifugal compressor diffuser structure having the configuration (1) described above; and

the impeller.

According to at least one embodiment of the present disclosure, the diffuser performance of a centrifugal compressor can be improved.

### BRIEF DESCRIPTION OF DRAWINGS

The disclosure will be described with reference to the accompanying drawings, wherein like numbers reference like elements.

FIG. 1 is a schematic cross-sectional view along the axial direction of a centrifugal compressor provided with a diffuser structure according to an embodiment.

FIG. 2 is a schematic cross-sectional view along the axial direction of a centrifugal compressor provided with a diffuser structure according to another embodiment.

FIG. 3 is a view taken along a line II-II in FIG. 1.

FIG. 4 is a graph illustrating the relationship between a vane height of a partial guide vane and a pressure recovery coefficient of static pressure in the diffuser structure.

FIG. 5 is a view for describing vane angles at a front edge and a rear edge of the partial guide vane.

FIG. 6 is a graph illustrating the relationship between the vane angle at the rear edge of the partial guide vane and a pressure loss coefficient of a scroll flow path.

FIG. 7 is a view for describing the vane angles.

### DESCRIPTION OF EMBODIMENTS

Embodiments of the present disclosure will be described hereinafter with reference to the appended drawings. It is intended, however, that unless particularly specified, dimensions, materials, shapes, relative positions and the like of components described in the embodiments shall be interpreted as illustrative only and not intended to limit the scope of the present disclosure.

For instance, an expression of relative or absolute arrangement such as “in a direction”, “along a direction”, “parallel”, “orthogonal”, “centered”, “concentric” and “coaxial” shall not be construed as indicating only the arrangement in a strict literal sense, but also includes a state where the arrangement is relatively displaced by a tolerance, or by an angle or a distance whereby it is possible to achieve the same function.

For instance, an expression of an equal state such as “same” “equal” and “uniform” shall not be construed as indicating only the state in which the feature is strictly equal, but also includes a state in which there is a tolerance or a difference that can still achieve the same function.

Further, for instance, an expression of a shape such as a rectangular shape or a cylindrical shape shall not be construed as only the geometrically strict shape, but also includes a shape with unevenness or chamfered corners within the range in which the same effect can be achieved.

On the other hand, an expression such as “comprise”, “include”, “have”, “contain” and “constitute” are not intended to be exclusive of other components.

### Overall Configuration of Centrifugal Compressor 1

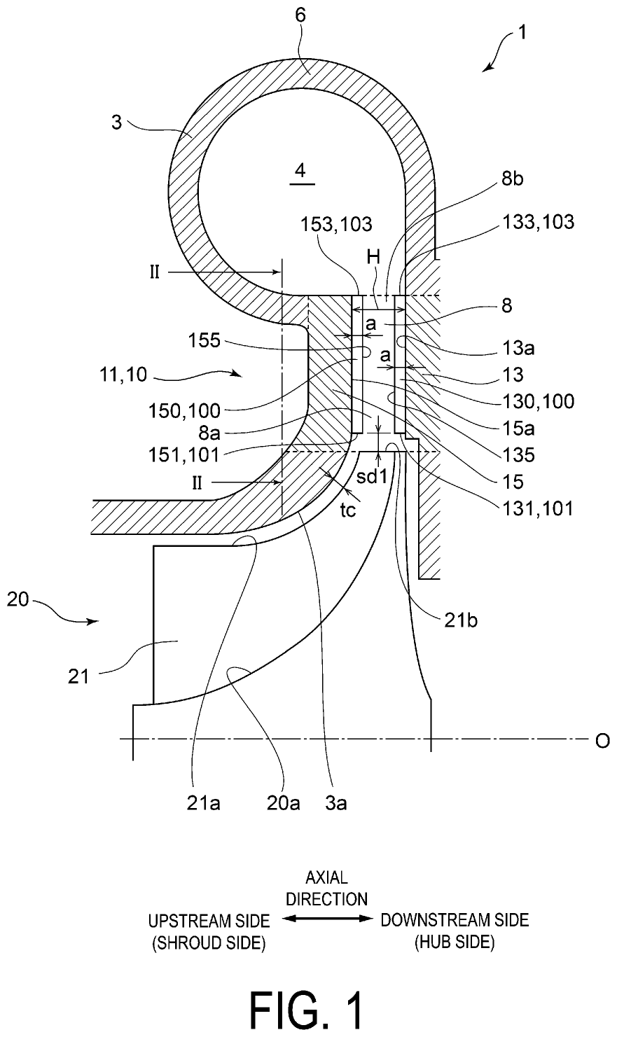

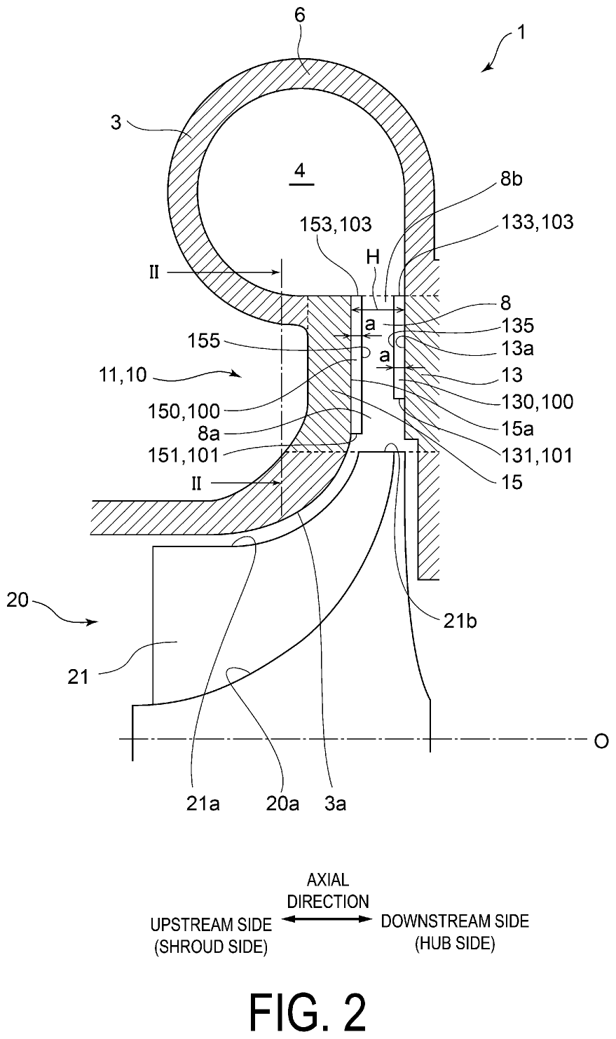

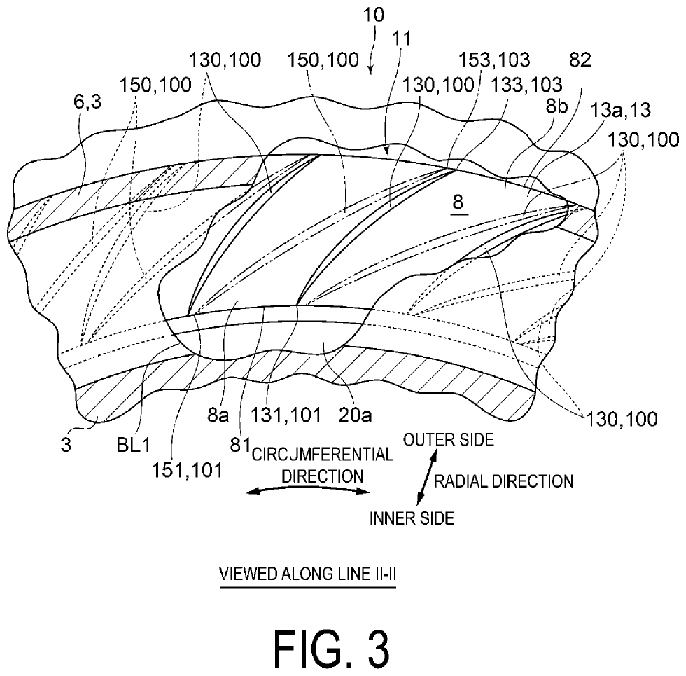

FIG. 1 is a schematic cross-sectional view along an axial direction of a centrifugal compressor 1 provided with a diffuser structure 10 according to an embodiment. FIG. 2 is a schematic cross-sectional view along an axial direction of a centrifugal compressor 1 provided with a diffuser structure 10 according to another embodiment. FIG. 3 is a view taken along a line II-II in FIG. 1 and is a schematic view for describing the diffuser structure 10 described below.

Note that the centrifugal compressor 1 can be applied to, for example, turbochargers for automobiles or vessels, or to other industrial centrifugal compressors, blowers, and the like.

In the following description, the axial direction of an impeller 20 described later, that is, the extension direction of a rotation center O is referred to as the axial direction. Of the axial direction, the upstream side along the flow of fluid flowing into the centrifugal compressor 1 is defined as the upstream side in the axial direction, and the opposite side thereof is defined as the downstream side in the axial direction. Note that when describing the diffuser structure 10 described below, the upstream side in the axial direction is also referred to as the shroud side, and the downstream side in the axial direction is also referred to as the hub side.

In addition, in the following description, the radial direction of the impeller 20 about the rotation center O is also referred to simply as the radial direction. Of the radial direction, the direction toward the rotation center O is defined as inwards in the radial direction, and the direction away from the rotation center O is defined as outwards in the radial direction.

In the following description, the direction along the rotational direction of the impeller 20 about the rotation center O is also referred to simply as “circumferential direction”.

Note that, in the following description, when referred to simply as the upstream side, the upstream side refers to the upstream side along the main flow direction of the fluid in the section or region related to the description of the direction. Similarly, in the following description, when referred to simply as the downstream side, the downstream side refers to the downstream side along the main flow direction of the fluid in the section or region related to the description of the direction.

The centrifugal compressor 1 according to some embodiments includes the impeller 20 and a casing 3, as illustrated in FIGS. 1 and 2, for example. The casing 3 includes a scroll section 6 that forms a scroll flow path 4 on the outer circumferential side of the impeller 20, and a diffuser structure 10 that is provided on the downstream side of the impeller 20 and includes a diffuser flow path 8 for supplying fluid (compressed air) compressed by the impeller 20 to the scroll flow path 4.

In some embodiments, the impeller 20 includes a plurality of blades 21 provided on the impeller 20 at intervals in the circumferential direction. Each of the plurality of blades 21 is vertically provided on a hub surface 20a of the impeller 20.

In some embodiments, a tip end 21a of each of the plurality of blades 21 is disposed with a predetermined gap with respect to an inner surface 3a of the casing 3. That is, the impeller 20 according to some embodiments is configured as an open-type impeller having no annular shroud member.

The diffuser structure 10 according to some embodiments includes a diffuser flow path-forming section 11 that forms the annular diffuser flow path 8 on the downstream side of the impeller 20, and a plurality of partial guide vanes 100 provided in the diffuser flow path 8 at intervals in the circumferential direction of the impeller 20. The plurality of partial guide vanes 100 will be described below in more detail below.

The diffuser flow path-forming section 11 is constituted by a pair of flow path walls 13, 15 that sandwich the diffuser flow path 8 therebetween in the axial direction of the impeller 20. Of the pair of flow path walls 13, 15, the flow path wall 13 on the hub side has a hub-side wall surface 13a that faces the diffuser flow path 8. The flow path wall 15 on the shroud side has a shroud-side wall surface 15a that is opposed to the hub-side wall surface 13a, faces the diffuser flow path 8, and defines the diffuser flow path 8 together with the hub-side wall surface 13a.

Note that, in FIGS. 1 and 2, the scroll section 6 and the diffuser flow path-forming section 11 are provided with different hatching for convenience. However, the casing 3 may be constituted by a plurality of casing components connected at any location regardless of the boundary position between the scroll section 6 and the diffuser flow path-forming section 11, which is represented by a dashed line for convenience. In addition to a compressor housing that accommodates the impeller 20, the casing 3 may also include a part of a bearing housing that accommodates a bearing for rotatably supporting the impeller 20.

### Partial Guide Vane 100

The diffuser structure 10 according to some embodiments illustrated in FIGS. 1 and 2 includes the plurality of partial guide vanes 100 provided in the diffuser flow path 8 at intervals in the circumferential direction of the impeller 20, as illustrated in FIG. 3, for example. The axial dimension of each of the plurality of partial guide vanes 100, that is, a vane height a is less than an axial height H of the diffuser flow path 8. In the diffuser structure 10 according to some embodiments illustrated in FIGS. 1 and 2, the plurality of partial guide vanes 100 include a plurality of hub-side partial guide vanes 130 provided on the hub-side wall surface 13a, and shroud-side partial guide vanes 150 provided on the shroud-side wall surface 15a. In FIG. 3, in a region illustrating the inside of the diffuser flow path 8, which is surrounded by a break line BL1, each of the shroud-side partial guide vanes 150 is represented by a long dashed double-short dashed line.

Note that, in the diffuser structure 10 according to some embodiments illustrated in FIGS. 1 to 3, the partial guide vane 100 may be provided only on either the hub-side wall surface 13a or the shroud-side wall surface 15a. That is, in the diffuser structure 10 according to some embodiments illustrated in FIGS. 1 to 3, the partial guide vane 100 may be provided on at least one of the hub-side wall surface 13a or the shroud-side wall surface 15a.

Each of the plurality of partial guide vanes 100 according to some embodiments illustrated in FIGS. 1 to 3 extends from a front edge 101, which is an end on the inner side in the radial direction, to a rear edge 103, which is an end on the outer side in the radial direction, of the partial guide vane 100.

For example, in the partial guide vane 100 according to the embodiment illustrated in FIGS. 1 and 3, the front edges 101 (front edges 131) of the hub-side partial guide vanes 130 and the front edges 101 (front edges 151) of the shroud-side partial guide vanes 150 each are located near an end of the diffuser flow path 8 on the inner side in the radial direction, that is, an end 81 on the side of an inlet 8a.

For example, in the partial guide vane 100 according to the embodiment illustrated in FIGS. 1 and 3, the rear edges 103 (rear edges 133) of the hub-side partial guide vanes 130 and the rear edges 103 (rear edges 153) of the shroud-side partial guide vanes 150 each are located near an end of the diffuser flow path 8 on the outer side in the radial direction, that is, an end 82 on the side of an outlet 8b.

Note that, for example, in the partial guide vane 100 according to the embodiment illustrated in FIGS. 1 and 3, each of the front edges 131 of the hub-side partial guide vanes 130 and the front edges 151 of the shroud-side partial guide vanes 150 may be configured such that a separation distance sdl between the front edges and a rear edge 21b of each of the plurality of blades 21 provided on the impeller 20 is reduced to a distance nearly equal to a tip clearance tc, which is a separation distance between the tip end 21a of each of the plurality of blades 21 and the inner surface 3a of the casing 3.

Also, in the partial guide vane 100 according to the embodiment illustrated in FIGS. 1 and 3, the radial position of each of the front edges 131 of the hub-side partial guide vanes 130 is the same as the radial position of each of the front edges 151 of the shroud-side partial guide vanes 150 but may be different therefrom. For example, in another embodiment illustrated in FIG. 2, the radial position of each of the front edges 131 of the hub-side partial guide vanes 130 is different from the radial position of each of the front edges 151 of the shroud-side partial guide vanes 150. For example, in the other embodiment illustrated in FIG. 2, each of the front edges 151 of the shroud-side partial guide vanes 150 is located inwards in the radial direction with respect to each of the front edges 131 of the hub-side partial guide vanes 130.

Note that each of the front edges 151 of the shroud-side partial guide vanes 150 may be located outwards in the radial direction with respect to each of the front edges 131 of the hub-side partial guide vanes 130.

In the partial guide vane 100 according to the embodiment illustrated in FIGS. 1 and 3, the radial position of each of the rear edges 133 of the hub-side partial guide vanes 130 is the same as the radial position of each of the rear edges 153 of the shroud-side partial guide vanes 150 but may be different therefrom.

In the following description, in the case where the hub-side partial guide vane 130 and the shroud-side partial guide vane 150 need not be distinguished from each other, the name “partial guide vane 100”, which is a generic name for the hub-side partial guide vane 130 and the shroud-side partial guide vane 150, and the name of each section of the partial guide vane 100, are used.

In the diffuser structure 10 according to some embodiments illustrated in FIGS. 1 to 3, the vane height a of each of the plurality of partial guide vanes 100 and the axial height H of the diffuser flow path 8 satisfy the relationship of 0.05 H≤a≤0.20 H.

That is, in the diffuser structure 10 according to some embodiments illustrated in FIGS. 1 to 3, in each of the plurality of hub-side partial guide vanes 130, a shroud-side vane tip 135 is separated from the shroud-side wall surface 15a and is exposed in the diffuser flow path 8. In the diffuser structure 10 according to some embodiments illustrated in FIGS. 1 to 3, a hub-side vane tip 155 of each of the plurality of shroud-side partial guide vanes 150 is separated from the hub-side wall surface 13a and is exposed in the diffuser flow path 8. In the diffuser structure 10 according to some embodiments illustrated in FIGS. 1 to 3, the shroud-side vane tip 135 of each of the plurality of hub-side partial guide vanes 130 is separated from the hub-side vane tip 155 of each of the plurality of shroud-side partial guide vanes 150 in the axial direction.

When a fluid is separated from the shroud-side wall surface 15a or the hub-side wall surface 13a in the diffuser flow path 8, retention or backflow of the fluid occurs in the fluid separating region, reducing the available flow path area of the diffuser flow path 8. As a result, there is a risk that the static pressure recovery performance (diffuser performance) of the diffuser (diffuser structure 10) decreases, and in turn, the performance of the centrifugal compressor 1 decreases. While it is conceivable that the diffuser flow path 8 be partially narrowed in order to suppress the separation of the fluid from the wall surfaces 13a, 15a, when the diffuser flow path 8 is partially narrowed, the cross-sectional area of the flow path decreases in the narrowed portion, possibly lowering the static pressure recovery performance in the diffuser.

In a vaned diffuser in which guide vanes are provided in the diffuser flow path 8, the separation of the fluid from the wall surfaces 13a, 15a is effectively suppressed by guiding the flow of the fluid with the guide vanes. In addition, although the vaned diffuser has the improved static pressure recovery performance as compared to a vaneless diffuser having no guide vane, chokes and stalls may be caused by the guide vanes and operation conditions for operating at a high efficiency tend to be narrower than those of the vaneless diffuser.

In addition, the vaneless diffuser tends to have lower static pressure recovery performance than the vaned diffuser, but can be used under wider operation conditions, as compared to the vaned diffuser.

As a result of diligent research, the inventors have found that it is advantageous to provide the partial guide vane 100 having the vane height a of not less than 5% and not greater than 20% of the axial height H of the diffuser flow path 8 on at least one of the hub-side wall surface 13a and the shroud-side wall surface 15a. Specifically, it has been found that by providing the partial guide vane 100 having the vane height a as described above on at least one of the hub-side wall surface 13a and the shroud-side wall surface 15a, separation of the fluid from the hub-side wall surface 13a or the shroud-side wall surface 15a can be effectively suppressed while suppressing the occurrence of chalks or stalls by the partial guide vane 100. It has also been found that by providing the partial guide vane 100 as described above, it is possible to operate with higher efficiency under wider operation conditions as compared to the vaned diffuser. Furthermore, it has been found that the vane height a of the partial guide vane 100 is more preferably not less than 10% and not greater than 15% of the axial height H of the diffuser flow path 8.

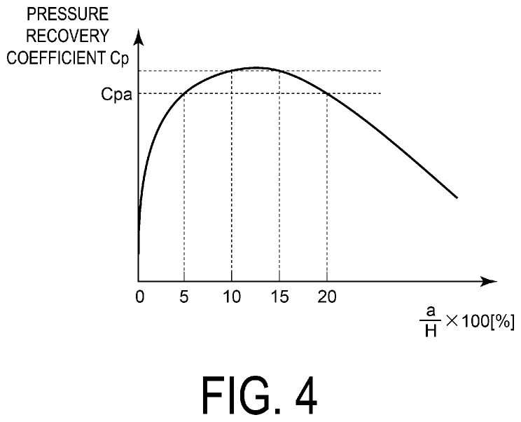

FIG. 4 is a graph illustrating the relationship between the vane height a of the partial guide vane 100 and a pressure recovery coefficient Cp of the static pressure in the diffuser structure 10. In the graph in FIG. 4, the horizontal axis represents the vane height a of the partial guide vane 100 given that the axial height H of the diffuser flow path 8 is set to 100%, and the vertical axis represents the static pressure recovery coefficient Cp. Note that the graph illustrated in FIG. 4 is a graph illustrating the case in which the partial guide vane 100 is provided on either the hub-side wall surface 13a or the shroud-side wall surface 15a.

As a result of diligent research, the inventors have found that, in the diffuser structure 10 according to some embodiments, in order to suppress the separation from the wall surface and acquire a high pressure recovery coefficient Cp, the vane height a of the partial guide vane 100 is preferably not less than 5% of the axial height H of the diffuser flow path 8, that is, 0.05 H≤a.

It has been found that in the diffuser structure 10 according to some embodiments, in order to suppress the separation from the wall surface and acquire a high pressure recovery coefficient Cp, the vane height a of the partial guide vane 100 is more preferably not less than 10% of the axial height H of the diffuser flow path 8, that is, 0.10 H≤a.

Note that when the partial guide vanes 100 are provided, the cross-sectional area of the flow path of the diffuser flow path 8 is temporarily narrowed at a throat section formed by the two adjacent partial guide vanes 100 in the circumferential direction, and the narrowing of the cross-sectional area of the flow path of the diffuser flow path 8 acts to suppress the static pressure recovery performance. Therefore, it has been found that when the vane height a of the partial guide vane 100 is too high, the effect of suppressing the static pressure recovery performance due to the throat section may exceed the effect of improving the static pressure recovery performance due to the suppression of the separation, and the required static pressure recovery coefficient Cpa may not be reached. Therefore, it has been found that the vane height a of the partial guide vane 100 is preferably not greater than 20% of the axial height H of the diffuser flow path 8, that is, a≤0.20 H. It has been found that the vane height a of the partial guide vane 100 is more preferably not greater than 15% of the axial height H of the diffuser flow path 8, that is, a≤0.15 H.

Therefore, since the diffuser structure 10 according to some embodiments illustrated in FIGS. 1 to 3 satisfies the relationship of 0.05 H≤a≤0.20 H, the separation of the fluid from the hub-side wall surface 13a or the shroud-side wall surface 15a can be effectively suppressed while suppressing the occurrence of chalks or stalls by the partial guide vane 100. This can improve the diffuser performance of the centrifugal compressor 1. Note that as described above, it is more preferred that the vane height a of the partial guide vane 100 satisfies the relationship of 0.10 H≤a≤0.15 H.

In the diffuser structure 10 according to some embodiments illustrated in FIGS. 1 to 3, the partial guide vane 100 preferably includes at least the shroud-side partial guide vane 150 provided on the shroud-side wall surface 15a.

Generally, under the operation condition with relatively high flow rate, the flow velocity of the fluid at the inlet 8a of the diffuser flow path 8 is often higher on the hub-side and lower on the shroud-side. As a result, under the operation condition with relatively high flow rate, the separation of the fluid tends to occur on the shroud-side wall surface 15a.

Since the diffuser structure 10 according to some embodiments illustrated in FIGS. 1 to 3 includes at least the shroud-side partial guide vane 150 provided on the shroud-side wall surface 15a, the separation of the fluid from the shroud-side wall surface 15a can be effectively suppressed. As a result, the diffuser performance of the centrifugal compressor 1 can be improved even under the operation conditions with relatively high flow rate.

In the diffuser structure 10 according to some embodiments illustrated in FIGS. 1 to 3, the partial guide vane 100 preferably includes at least the hub-side partial guide vane 130 provided on the hub-side wall surface 13a.

In general, under the operation condition with relatively low flow rate, the separation of the fluid tends to occur on the hub-side wall surface 13a.

Since the diffuser structure 10 according to some embodiments illustrated in FIGS. 1 to 3 includes at least the hub-side partial guide vane 130 provided on the hub-side wall surface 13a, the separation of the fluid from the hub-side wall surface 13a can be effectively suppressed. As a result, the diffuser performance of the centrifugal compressor 1 can be improved even under the operation conditions with relatively low flow rate.

In the diffuser structure 10 according to some embodiments illustrated in FIGS. 1 to 3, the partial guide vane 100 preferably includes the shroud-side partial guide vane 150 provided on the shroud-side wall surface 15a, and the hub-side partial guide vane 130 provided on the hub-side wall surface 13a.

In the diffuser structure 10 according to some embodiments illustrated in FIGS. 1 to 3, since the partial guide vane 100 includes the shroud-side partial guide vane 150 and the hub-side partial guide vane 130, the separation of the fluid from the shroud-side wall surface 15a and the hub-side wall surface 13a can be effectively suppressed. As a result, the diffuser performance of the centrifugal compressor 1 can be improved in a wide range of relatively low flow rate to relatively high flow rate.

In the diffuser structure 10 according to some embodiments illustrated in FIGS. 1 to 3, when the partial guide vane 100 includes the shroud-side partial guide vane 150 and the hub-side partial guide vane 130, the number of the shroud-side partial guide vanes 150 may be the same as or different from the number of hub-side partial guide vanes 130. Note that to increase the effect of guiding the fluid, the large number of shroud-side partial guide vanes 150 and hub-side partial guide vanes 130 are desirable. Thus, the number of the guide vanes may be appropriately set in consideration of disadvantages in which the increase in the number of the guide vanes decreases the effective cross-sectional area of the flow path of the diffuser flow path 8 and increases the flow path resistance.

Also, when viewed from the axial direction, the shroud-side partial guide vane 150 and the hub-side partial guide vane 130 need not overlap each other, for example, as illustrated in FIG. 3, or may partially overlap each other.

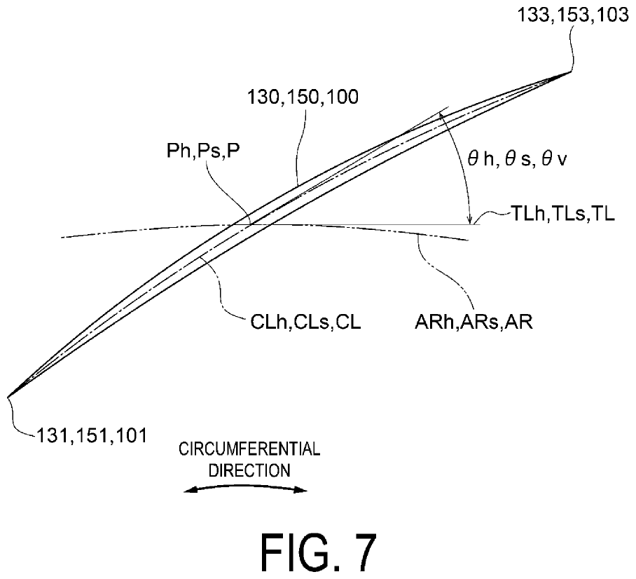

FIG. 7 is a schematic view for describing a vane angle θv when viewed along the axial direction.

The angle formed between a camber line CL of the partial guide vane 100 and a tangent line TL in the circumferential direction of the centrifugal compressor 1 at any position P on the camber line CL is defined as the vane angle θv. Note that in FIG. 7, a circular arc AR of a circle passing through the position P on the camber line CL around the rotation center O is expressed by a long dashed double-short dashed line.

Note that the camber line CL is a line connecting centers of the vane thickness from the front edge 101 to the rear edge 103 of the partial guide vane 100.

The vane angle θv of the hub-side partial guide vane 130, that is, the angle formed between a camber line CLh of the hub-side partial guide vane 130 and a tangent line TLh in the circumferential direction of the centrifugal compressor 1 at any position Ph on the camber line CLh is defined as a hub-side vane angle θh. Note that in FIG. 7, a circular arc ARh of a circle passing through the position Ph on the camber line CLh around the rotation center O is expressed by a long dashed double-short dashed line.

The vane angle θv of the shroud-side partial guide vane 150, that is, the angle formed between a camber line CLs of the shroud-side partial guide vane 150 and a tangent line TLs in the circumferential direction of the centrifugal compressor 1 at any position Ps on the camber line CLs is defined as a shroud-side vane angle θs. Note that in FIG. 7, a circular arc ARs of a circle passing through the position Ps on the camber line CLs around the rotation center O is expressed by a long dashed double-short dashed line.

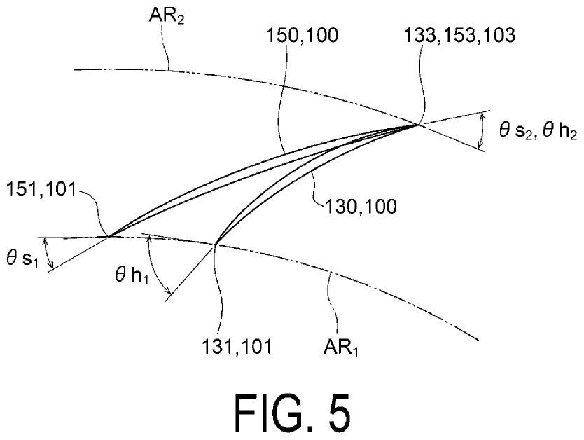

FIG. 5 is a schematic view for describing the vane angle θv at the front edge 101 and the rear edge 103 of the partial guide vane 100 when viewed along the axial direction. For convenience of explanation, in FIG. 5, the rear edge 133 of the hub-side partial guide vane 130 and the rear edge 153 of the shroud-side partial guide vane 150 are disposed at the same position. In FIG. 5, of circular arcs represented by long dashed double-short dashed lines, a circular arc AR₁ having a smaller diameter is a circular arc of a circle passing through the front edge 101 around the rotation center O, and a circular arc AR₂ having a larger diameter is a circular arc of a circle passing through the rear edge 103 around the rotation center O.

### First Shroud-Side Vane Angle θs₁

In the diffuser structure 10 according to some embodiments illustrated in FIGS. 1 to 3, a first shroud-side vane angle θs₁, which is the shroud-side vane angle θs at the front edge 151 of the shroud-side partial guide vane 150, is preferably not greater than 30 degrees.

As a result of diligent research, the inventors have found that when the first shroud-side vane angle θs₁ exceeds 30 degrees, a difference between the angle of the flow of fluid at the inlet 8a of the diffuser flow path 8 and the first shroud-side vane angle θs₁ increases to increase loss, possibly decreasing the static pressure recovery performance.

That is, the angle of the flow of the fluid in the vicinity of the shroud-side wall surface 15a decreases relative to the main flow (primary flow) of the fluid due to the influence of the boundary layer. The angle is generally not greater than 30 degrees, and in order to install the shroud-side partial guide vane 150 along the flow, the shroud-side vane angle θs₁ is preferably not greater than 30 degrees.

Note that in the following description, the angle of the flow of the fluid at the inlet 8a of the diffuser flow path 8 is also referred to simply as flow angle.

In the diffuser structure 10 according to some embodiments illustrated in FIGS. 1 to 3, by setting the first shroud-side vane angle θs₁ to be 30 degrees or less, a loss caused by a difference between the flow angle of the fluid at the inlet 8a of the diffuser flow path 8 and the first shroud-side vane angle θs₁ can be suppressed to ensure the static pressure recovery performance.

Note that the first shroud-side vane angle θs₁ is more preferably not greater than 20 degrees.

However, when the first shroud-side vane angle θs₁ is less than 5 degrees, the length of the shroud-side partial guide vane 150 becomes large, making it difficult to manufacture the diffuser structure 10 having the shroud-side partial guide vane 150. In addition, when the first shroud-side vane angle θs1 is less than 5 degrees, there is a risk that the effect of the flow path resistance increased with an increase in the length of the shroud-side partial guide vane 150 exceeds the effect of improving the static pressure recovery performance due to the suppression of separation. Thus, the first shroud-side vane angle θs₁ is preferably not less than 5 degrees.

### First Hub-Side Vane Angle θh₁

In the diffuser structure 10 according to some embodiments illustrated in FIGS. 1 to 3, the first hub-side vane angle θh₁, which is the hub-side vane angle θh at the front edge 131 of the hub-side partial guide vane 130, is preferably 50 degrees or less.

As a result of diligent research, the inventors have found that when the first hub-side vane angle θh₁ exceeds 50 degrees, the difference between the flow angle of the fluid at the inlet 8a of the diffuser flow path 8 and the first hub-side vane angle θh₁ increases to increase a loss, possibly deceasing the static pressure recovery performance.

In the diffuser structure 10 according to some embodiments illustrated in FIGS. 1 to 3, by setting the first hub-side vane angle θh₁ to be 50 degrees or less, a loss caused by a difference between the flow angle of the fluid at the inlet 8a of the diffuser flow path 8 and the first hub-side vane angle θh₁ can be suppressed to ensure the static pressure recovery performance.

Note that the first hub-side vane angle θh₁ is, more preferably not greater than 40 degrees.

However, when the first hub-side vane angle θh₁ is less than 5 degrees, the length of the hub-side partial guide vane 130 becomes large, making it difficult to manufacture the diffuser structure 10 having the hub-side partial guide vane 130. In addition, when the first hub-side vane angle θh₁ is less than 5 degrees, there is a risk that the effect of the flow path resistance increased with an increase in the length of the hub-side partial guide vane 130 exceeds the effect of improving the static pressure recovery performance due to the suppression of separation. Thus, the first hub-side vane angle θh₁ is preferably not less than 5 degrees.

### First Shroud-Side Vane Angle θs₁ and First Hub-Side Vane Angle θh₁

In the diffuser structure 10 according to some embodiments illustrated in FIGS. 1 to 3, the first shroud-side vane angle θs₁ is preferably smaller than the first hub-side vane angle θh₁.

Generally, the flow angle of the fluid at the inlet 8a of the diffuser flow path 8 is often smaller on the shroud-side than on the hub-side.

In the diffuser structure 10 according to some embodiments illustrated in FIGS. 1 to 3, since the first shroud-side vane angle θs₁ is smaller than the first hub-side vane angle θh₁, the difference between the flow angle of the fluid flowing near the shroud-side wall surface 15a at the inlet 8a of the diffuser flow path 8 and the first shroud-side vane angle θs₁ can be suppressed, and the difference between the flow angle of the fluid flowing near the hub-side wall surface 13a at the inlet 8a of the diffuser flow path 8 and the first hub-side vane angle θh₁ can also be suppressed. As a result, a loss caused by the difference between the flow angle of the fluid flowing in the vicinity of the shroud-side wall surface 15a at the inlet 8a of the diffuser flow path 8 and the first shroud-side vane angle θs₁, and a loss caused by the difference between the flow angle of the fluid flowing near the hub-side wall surface 13a at the inlet 8a of the diffuser flow path 8 and the first hub-side vane angle θh₁ can be suppressed to ensure the static pressure recovery performance.

### Second Shroud-side Vane Angle θs₂

In the diffuser structure 10 according to some embodiments illustrated in FIGS. 1 to 3, a second shroud-side vane angle θs₂, which is the shroud-side vane angle θs at the rear edge 153 of the shroud-side partial guide vane 150, is preferably 50 degrees or less.

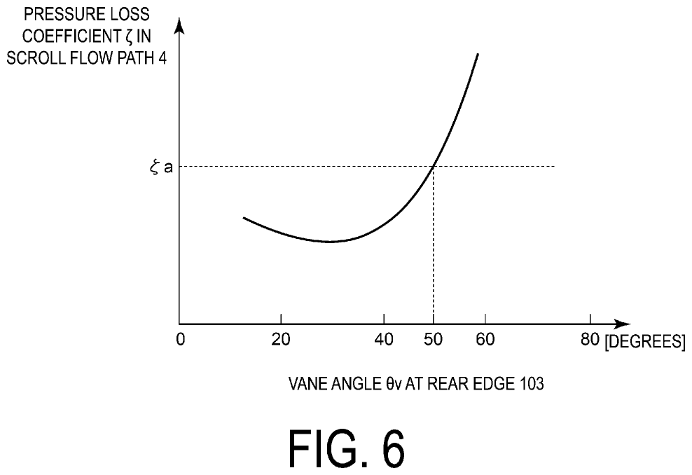

FIG. 6 is a graph illustrating the relationship between the vane angle θv at the rear edge 103 of the partial guide vane 100 and a pressure loss coefficient ζ in the scroll flow path 4.

As a result of diligent research, as illustrated in FIG. 6, the inventors have found that when the vane angle θv at the rear edge 103 of the partial guide vane 100 exceeds 50 degrees, the pressure loss coefficient ζ in the scroll flow path 4 suddenly increases and exceeds a permissible value ζa. In other words, it was found that when the second shroud-side vane angle θs₂ exceeds 50 degrees, the pressure loss coefficient ζ in the scroll flow path 4 suddenly increases and exceeds the permissible value ζa.

According to the diffuser structure 10 according to some embodiments illustrated in FIGS. 1 to 3, by setting the second shroud-side vane angle θs₂ to be 50 degrees or less, the pressure loss coefficient ζ in the scroll flow path 4 can be suppressed within a permissible range, thereby suppressing the pressure loss in the scroll flow path 4 and ensuring the static pressure recovery performance.

Note that the second shroud-side vane angle θs₂ is preferably not less than the first shroud-side vane angle θs₁. This is because when the second shroud-side vane angle θs₂ is less than the first shroud-side vane angle θs₁, the effect of directing the flow of fluid outwards in the radial direction in the diffuser flow path 8 cannot be sufficiently acquired.

### Second Hub-Side Vane Angle θh₂

In the diffuser structure 10 according to some embodiments illustrated in FIGS. 1 to 3, the second hub-side vane angle θh₂, which is the hub-side vane angle θh at the rear edge 133 of the hub-side partial guide vane 130, is preferably 50 degrees or less.

As described above, when the vane angle θv at the rear edge 103 of the partial guide vane 100 exceeds 50 degrees, the pressure loss coefficient ζ in the scroll flow path 4 suddenly increases and exceeds the permissible value ζa. In other words, when the second hub-side vane angle θh₂ exceeds 50 degrees, the pressure loss coefficient ζ in the scroll flow path 4 suddenly increases and exceeds the permissible value ζa.

According to the diffuser structure 10 according to some embodiments illustrated in FIGS. 1 to 3, by setting the second hub-side vane angle θh₂ to be 50 degrees or less, the pressure loss coefficient in the scroll flow path 4 can be suppressed within the permissible range, thereby suppressing the pressure loss in the scroll flow path 4 and ensuring the static pressure recovery performance.

Note that the second hub-side vane angle θh₂ is preferably not less than the first hub-side vane angle θh₁. This is because when the second hub-side vane angle θh₂ is less than the first hub-side vane angle θh₁, the effect of directing the flow of fluid outwards in the radial direction in the diffuser flow path 8 cannot be sufficiently acquired.

### Second Shroud-Side Vane Angle θs₂ and Second Hub-side Vane Angle θh₂

In the diffuser structure 10 according to some embodiments illustrated in FIGS. 1 to 3, the difference between the second shroud-side vane angle θs₂ and the second hub-side vane angle θh₂ is preferably 10 degrees or less.

The scroll flow path 4 is disposed downstream from the rear edge 153 of the shroud-side partial guide vane 150 and the rear edge 133 of the hub-side partial guide vane 130. Thus, it is desirable to flow the fluid from the diffuser flow path 8 to the scroll flow path 4 as uniformly as possible by making the flow angle of the fluid flowing into the scroll flow path 4 on the shroud side and the hub side to be the same to the extent possible.

As a result of diligent research, the inventors have found that when the shroud-side partial guide vane 150 and the hub-side partial guide vane 130 are provided, the difference between the second shroud-side vane angle θs₂ and the second hub-side vane angle θh₂ is preferably 10 degrees or less.

According to the diffuser structure 10 according to some embodiments illustrated in FIGS. 1 to 3, by setting the difference between the second shroud-side vane angle θs₂ and the second hub-side vane angle θh₂ to be 10 degrees or less, the loss in the scroll flow path 4 can be suppressed to improve the efficiency of the centrifugal compressor 1.

### Diffuser Structure 10 According to Another Embodiment Illustrated in FIG. 2

In the diffuser structure 10 according to another embodiment illustrated in FIG. 2, the front edge 151 of the shroud-side partial guide vane 150 is located inwards in the radial direction with respect to the front edge 131 of the hub-side partial guide vane 130.

Generally, the separation of the fluid from the shroud-side wall surface 15a often occurs entirely from the inlet 8a to the outlet 8b in the diffuser flow path 8. In addition, the separation of the fluid from the hub-side wall surface 13a is unlikely to occur in the region near the inlet 8a of the diffuser flow path 8, and often occurs after the fluid flows from the vicinity of the inlet 8a toward the outlet 8b to some extent.

In the diffuser structure 10 according to the other embodiment illustrated in FIG. 2, since the front edge 151 of the shroud-side partial guide vane 150 is positioned inwards in the radial direction with respect to the front edge 131 of the hub-side partial guide vane 130, the shroud-side partial guide vane 150 and the hub-side partial guide vane 130 can be disposed in the region in the diffuser flow path 8 where the fluid tends to be separated.

Since the centrifugal compressor 1 according to some embodiments includes the diffuser structure 10 according to some embodiments illustrated in FIGS. 1 to 3, the diffuser performance can be improved to improve the efficiency of the centrifugal compressor 1.

The present disclosure is not limited to the embodiments described above, and also includes a modification of the above-described embodiments as well as appropriate combinations of these modes.

For example, in some embodiments described above, the vane height a of the shroud-side partial guide vane 150 may be the same as or different from the vane height a of the hub-side partial guide vane 130.

In some embodiments described above, the vane height a of the partial guide vane 100 may be uniform from the front edge 101 to the rear edge 103, and may vary within a range of 0.05 H≤a≤0.20 H depending on the position on the camber line CL.

The contents of the embodiments described above can be construed as follows, for example.

(1) A diffuser structure 10 of a centrifugal compressor 1 according to at least one embodiment of the present disclosure is a diffuser structure 10 provided downstream from an impeller 20 of the centrifugal compressor 1, and includes a hub-side wall surface 13a, a shroud-side wall surface 15a that defines, together with the hub-side wall surface 13a, a diffuser flow path 8, and a partial guide vane 100 provided on at least one of the hub-side wall surface 13a and the shroud-side wall surface 15a. In the diffuser structure 10 of the centrifugal compressor 1 according to at least one embodiment of the present disclosure, given that a vane height of the partial guide vane 100 is a, and an axial height of the diffuser flow path 8 is H, a relationship of 0.05 H≤a≤0.20 H is satisfied.

As described above, as a result of diligent research, the inventors have found that it is advantageous to provide the partial guide vane 100 having the vane height a of not less than 5% and not greater than 20% of the axial height H of the diffuser flow path 8 on at least one of the hub-side wall surface 13a and the shroud-side wall surface 15a. Therefore, according to the configuration of (1) described above, it is possible to effectively suppress the separation of the fluid from the hub-side wall surface 13a or the shroud-side wall surface 15a while suppressing the occurrence of chalks and stalls by the partial guide vane 100. This can improve the diffuser performance of the centrifugal compressor 1.

(2) In some embodiments, in the configuration of (1) described above, the vane height a of the partial guide vane 100 satisfies the relationship of 0.10 H≤a≤0.15 H.

As described above, the vane height a of the partial guide vane 100 more preferably satisfies the relationship of 0.10 H≤a≤0.15 H. Therefore, according to the configuration of (2) described above, it is possible to more effectively suppress the separation of the fluid from the hub-side wall surface 13a or the shroud-side wall surface 15a while suppressing the occurrence of chalks and stalls by the partial guide vane 100. As a result, the diffuser performance of the centrifugal compressor 1 can be further improved.

(3) In some embodiments, in the configuration of (1) or (2) described above, the vane height a of the partial guide vane 100 is the vane height of a hub-side partial guide vane 130 provided on the hub-side wall surface 13a, or a vane height of the shroud-side partial guide vane 150 provided on the shroud-side wall surface 15a.

According to the configuration of (3) described above, since the vane height a of the hub-side partial guide vane 130 or the vane height a of the shroud-side partial guide vane 150 satisfies the relationship in the configuration of (1) or (2) above, it is possible to effectively suppress the separation of the fluid from the hub-side wall surface 13a or the shroud-side wall surface 15a while suppressing the occurrence of chalks or stalls by the partial guide vane 100.

(4) In some embodiments, in any one of the configurations of (1) to (3) described above, the partial guide vane 100 includes at least the shroud-side partial guide vane 150 provided on the shroud-side wall surface 15a.

As described above, in general, under the operation condition with relatively high flow rate, the flow velocity of the fluid at the inlet 8a of the diffuser flow path 8 is often higher on the hub side and lower on the shroud side. As a result, under the operation condition with relatively high flow rate, the separation of the fluid tends to occur on the shroud-side wall surface 15a.

According to the configuration of (4) described above, since at least the shroud-side partial guide vane 150 provided on the shroud-side wall surface 15a is included, the separation of the fluid from the shroud-side wall surface 15a can be effectively suppressed. As a result, the diffuser performance of the centrifugal compressor 1 can be improved even under the operation conditions with relatively high flow rate.

(5) In some embodiments, in the configuration of (4) described above, the first shroud-side vane angle θs₁, which is the shroud-side vane angle θs at the front edge 151 of the shroud-side partial guide vane 150, is preferably 30 degrees or less.

According to the configuration of (5) described above, by setting the first shroud-side vane angle θs₁ to be 30 degrees or less, a loss caused by a difference between the flow angle of the fluid at the inlet 8a of the diffuser flow path 8 and the first shroud-side vane angle θs₁ can be suppressed to ensure the static pressure recovery performance.

(6) In some embodiments, in the configuration of (4) or (5) described above, the second shroud-side vane angle θs₂, which is the shroud-side vane angle θs at the rear edge 153 of the shroud-side partial guide vane 150, is preferably 50 degrees or less.

According to the configuration of (6) described above, by setting the second shroud-side vane angle θs₂ to be 50 degrees or less, the pressure loss coefficient ζ in the scroll flow path 4 can be suppressed within the permissible range, thereby suppressing the pressure loss in the scroll flow path 4 and ensuring the static pressure recovery performance.

(7) In some embodiments, in any one of the above-described configurations of (1) to (6), the partial guide vane 100 includes at least the hub-side partial guide vane 130 provided on the hub-side wall surface 13a.

As described above, in general, under the operation condition with relatively low flow rate, the separation of the fluid tends to occur on the hub-side wall surface 13a.

According to the configuration of (7) described above, since at least the hub-side partial guide vane 130 provided on the hub-side wall surface 13a is included, the separation of the fluid from the hub-side wall surface 13a can be effectively suppressed. As a result, the diffuser performance of the centrifugal compressor 1 can be improved even under the operation conditions with relatively low flow rate.

(8) In some embodiments, in the configuration of (7) described above, the first hub-side vane angle θh₁, which is the hub-side vane angle θh at the front edge 131 of the hub-side partial guide vane 130, is preferably 50 degrees or less.

According to the configuration of (8) above, by setting the first hub-side vane angle θh₁ to be 50 degrees or less, a loss caused by a difference between the flow angle of the fluid at the inlet 8a of the diffuser flow path 8 and the first hub-side vane angle θh₁ can be suppressed to ensure the static pressure recovery performance.

(9) In some embodiments, in the configuration of (7) or (8) described above, the second hub-side vane angle θh₂, which is the hub-side vane angle θh at the rear edge 133 of the hub-side partial guide vane 130, is preferably 50 degrees or less.

According to the configuration of (9) described above, by setting the second hub-side vane angle θh₂ to be 50 degrees or less, the pressure loss coefficient ζ in the scroll flow path 4 can be suppressed within the permissible range, thereby suppressing the pressure loss in the scroll flow path 4 and ensuring the static pressure recovery performance.

(10) In some embodiments, in any one of the configurations of (1) to (9) described above, the partial guide vane 100 preferably includes the shroud-side partial guide vane 150 provided on the shroud-side wall surface 15a, and the hub-side partial guide vane 130 provided on the hub-side wall surface 13a.

As described above, under the operation condition with relatively high flow rate, the flow velocity of the fluid at the inlet of the diffuser flow path is often higher on the hub-side and lower on the shroud-side. As a result, under the operation condition with relatively high flow rate, the separation of the fluid tends to occur on the shroud-side wall surface. In addition, in general, under the operation condition with relatively low flow rate, the separation of the fluid tends to occur on the hub-side wall surface.

According to the configuration of (10) described above, since the partial guide vane 100 includes the shroud-side partial guide vane 150 and the hub-side partial guide vane 130, the separation of the fluid from the shroud-side wall surface 15a and the hub-side wall surface 13a can be effectively suppressed. As a result, the diffuser performance of the centrifugal compressor 1 can be improved in a wide range of relatively low flow rate to relatively high flow rate.

(11) In some embodiments, in the configuration of (10) described above, the first shroud-side vane angle θs₁, which is the shroud-side vane angle θs at the front edge 151 of the shroud-side partial guide vane 150, is smaller than the first hub-side vane angle θh₁, which is the hub-side vane angle θh at the front edge 131 of the hub-side partial guide vane 130.

As described above, in general, the flow angle of the fluid at the inlet 8a of the diffuser flow path 8 is often smaller on the shroud-side than on the hub-side.

In the configuration of (11) described above, since the first shroud-side vane angle θs₁ is smaller than the first hub-side vane angle θh₁, the difference between the flow angle of the fluid flowing near the shroud-side wall surface 15a at the inlet 8a of the diffuser flow path 8 and the first shroud-side vane angle θs₁ can be suppressed, and the difference between the flow angle of the fluid flowing near the hub-side wall surface 13a at the inlet 8a of the diffuser flow path 8 and the first hub-side vane angle θh₁ can also be suppressed. As a result, a loss caused by the difference between the flow angle of the fluid flowing in the vicinity of the shroud-side wall surface 15a at the inlet 8a of the diffuser flow path 8 and the first shroud-side vane angle θs₁, and a loss caused by the difference between the flow angle of the fluid flowing near the hub-side wall surface 13a at the inlet 8a of the diffuser flow path 8 and the first hub-side vane angle θh₁ can be suppressed to ensure the static pressure recovery performance.

(12) In some embodiments, in the configuration of (10) or (11) above, the difference between the second shroud-side vane angle θs₂, which is the shroud-side vane angle θs at the rear edge 153 of the shroud-side partial guide vane 150, and the second hub-side vane angle θh₂, which is the hub-side vane angle θh at the rear edge 133 of the hub-side partial guide vane 130, is 10 degrees or less.

As described above, as a result of diligent research, the inventors have found that when the shroud-side partial guide vane 150 and the hub-side partial guide vane 130 are provided, the difference between the second shroud-side vane angle θs₂ and the second hub-side vane angle θh₂ is preferably 10 degrees or less.

According to the configuration of (12) described above, since the difference between the second shroud-side vane angle θs₂ and the second hub-side vane angle θh₂ is 10 degrees or less, the loss in the scroll flow path 4 can be suppressed to improve the efficiency of the centrifugal compressor.

(13) In some embodiments, in the configuration of any of the above (10) to (12), the front edge 151 of the shroud-side partial guide vane 150 is located inwards in the radial direction with respect to the front edge 131 of the hub-side partial guide vane 130.

As described above, in general, the separation of the fluid from the shroud-side wall surface 15a often occurs entirely from the inlet 8a to the outlet 8b in the diffuser flow path 8. In addition, the separation of the fluid from the hub-side wall surface 13a is unlikely to occur in the region near the inlet 8a of the diffuser flow path 8, and often occurs after the fluid flows from the vicinity of the inlet 8a toward the outlet 8b to some extent.

According to the configuration of (13) described above, since the front edge 151 of the shroud-side partial guide vane 150 is positioned inwards in the radial direction with respect to the front edge 131 of the hub-side partial guide vane 130, the shroud-side partial guide vane 150 and the hub-side partial guide vane 130 can be disposed in the region in the diffuser flow path 8 where the fluid tends to be separated.

(14) A centrifugal compressor 1 according to at least one embodiment of the present disclosure includes the diffuser structure 10 of the centrifugal compressor 1 according to any one of the above-described configurations of (1) to (13), and the impeller 20.

According to the configuration of (14) described above, since the diffuser structure 10 of the centrifugal compressor 1 according to any one of the above-described configurations of (1) to (13) is included, the diffuser performance can be improved, and in turn, the efficiency of the centrifugal compressor 1 can be improved.

While preferred embodiments of the invention have been described as above, it is to be understood that variations and modifications will be apparent to those skilled in the art without departing from the scope and spirit of the invention. The scope of the invention, therefore, is to be determined solely by the following claims.

1. A centrifugal compressor diffuser structure provided on a downstream side of an impeller of a centrifugal compressor, the centrifugal compressor diffuser structure comprising:
a hub-side wall surface;
a shroud-side wall surface defining, together with the hub-side wall surface, a diffuser flow path; and
a partial guide vane provided on at least one of the hub-side wall surface and the shroud-side wall surface, wherein
given that a vane height of the partial guide vane is a, and
an axial height of the diffuser flow path is H,
a relationship 0.05 H≤a≤0.20 H is satisfied.

2. The centrifugal compressor diffuser structure according to claim 1, wherein
the vane height a of the partial guide vane satisfies a relationship of 0.10 H≤a≤0.15 H.

3. The centrifugal compressor diffuser structure according to claim 1, wherein
the vane height a of the partial guide vane is a vane height of a hub-side partial guide vane provided on the hub-side wall surface, or a vane height of a shroud-side partial guide vane provided on the shroud-side wall surface.

4. The centrifugal compressor diffuser structure according to claim 1, wherein
the partial guide vane includes at least the shroud-side partial guide vane provided on the shroud-side wall surface.

5. The centrifugal compressor diffuser structure according to claim 4, wherein
given that an angle formed between a camber line of the shroud-side partial guide vane and a tangent line of the centrifugal compressor in a circumferential direction at any position on the camber line is a shroud-side vane angle θs,
a first shroud-side vane angle θs₁ that is the shroud-side vane angle θs at a front edge of the shroud-side partial guide vane is not greater than 30 degrees.

6. The centrifugal compressor diffuser structure according to claim 4, wherein
given that an angle formed between a camber line of the shroud-side partial guide vane and a tangent line of the centrifugal compressor in the circumferential direction at any position on the camber line is a shroud-side vane angle θs,
a second shroud-side vane angle θs₂ that is the shroud-side vane angle θs at a rear edge of the shroud-side partial guide vane is not greater than 50 degrees.

7. The centrifugal compressor diffuser structure according to claim 1, wherein
the partial guide vane includes at least the hub-side partial guide vane provided on the hub-side wall surface.

8. The centrifugal compressor diffuser structure according to claim 7, wherein
given that an angle formed between a camber line of the hub-side partial guide vane and a tangent line of the centrifugal compressor in the circumferential direction at any position on the camber line is a hub-side vane angle θh,
a first hub-side vane angle θs₁ that is the hub-side vane angle θh at a front edge of the hub-side partial guide vane is not greater than 50 degrees.

9. The centrifugal compressor diffuser structure according to claim 7, wherein
given that an angle formed between a camber line of the hub-side partial guide vane and a tangent line of the centrifugal compressor in the circumferential direction at any position on the camber line is a hub-side vane angle θh,
a second hub-side vane angle θs₂ that is the hub-side vane angle θh at a rear edge of the hub-side partial guide vane is not greater than 50 degrees.

10. The centrifugal compressor diffuser structure according to claim 1, wherein
the partial guide vane includes the shroud-side partial guide vane provided on the shroud-side wall surface and the hub-side partial guide vane provided on the hub-side wall surface.

11. The centrifugal compressor diffuser structure according to claim 10, wherein
given that an angle formed between a camber line of the shroud-side partial guide vane and a tangent line of the centrifugal compressor in the circumferential direction at any position on the camber line is a shroud-side vane angle θs, and
that an angle formed between a camber line of the hub-side partial guide vane and a tangent line of the centrifugal compressor in the circumferential direction at any position on the camber line is a hub-side vane angle θh,
a first shroud-side vane angle θs₁ that is the shroud-side vane angle θs at a front edge of the shroud-side partial guide vane is smaller than a first hub-side vane angle θh₁ that is the hub-side vane angle θh at a front edge of the hub-side partial guide vane.

12. The centrifugal compressor diffuser structure according to claim 10, wherein
given that an angle formed between a camber line of the shroud-side partial guide vane and a tangent line of the centrifugal compressor in the circumferential direction at any position on the camber line is a shroud-side vane angle θs, and
that an angle formed between a camber line of the hub-side partial guide vane and a tangent line of the centrifugal compressor in the circumferential direction at any position on the camber line is a hub-side vane angle θh,
a difference between a second shroud-side vane angle θs₂ that is the shroud-side vane angle θs at a rear edge of the shroud-side partial guide vane and a second hub-side vane angle θh₂ that is the hub-side vane angle θh at a rear edge of the hub-side partial guide vane is not greater than 10 degrees.

13. The centrifugal compressor diffuser structure according to claim 10, wherein
a front edge of the shroud-side partial guide vane is located inwards in the radial direction with respect to a front edge of the hub-side partial guide vane.

14. A centrifugal compressor comprising:
the centrifugal compressor diffuser structure described in claim 1; and
the impeller.
